(19) United States
(12) Patent Application Publication
(10) Pub. No.: US 2017/0209824 A1
(43) Pub. Date: Jul. 27, 2017

(54) Low Water Usage Wet Scrubber

(71) Applicant: Kenneth Abbott, Tucson, AZ (US)

(72) Inventor: Kenneth Abbott, Tucson, AZ (US)

(73) Assignee: J&K Management Inc.

(21) Appl. No.: 14/998,623

(22) Filed: Jan. 25, 2016

(51) Int. Cl. B01D 47/06; B01D 50/00; B01D 45/10

(52) U.S. Cl. CPC B01D 47/06; B01D 45/10; B01D 50/004

(57) ABSTRACT

The invention creates a dust collector having a container through which the dirty air passes. The container includes an inlet for acceptance of dirty air and an outlet for exhaustion of clean air. In the preferred embodiment, between the inlet and outlet is a serpentine pathway into which a fogging apparatus emits a fog of water to capture dust particles in the air passing therethrough. An alternative embodiment passes a dirty airflow through the fog while creating turbulence within the airflow to enhance contact between the fog and dirt particles.

### BACKGROUND OF THE INVENTION

This invention relates generally to filtration systems and more particularly to filtration systems used to remove air-borne particulates using water as the filtration medium.

Air filtration continues to be an ever increasing problem, and many applications are unable to use a standard dry filter filtration system due to the hazardous nature of the particles (explosive in nature). Often water, moisture, or other forms of water soluble liquids are used in a particular process generating the dust. In these situations, the moisture is co-mingled with the air borne particles. When a dry filtration apparatus is used, the wet medium only forms a “mud” and clogs the filtration's screens.

This is a particular concern for industries such as tunneling operations which generate an inordinate amount of dust and other airborne debris, and at the same time are required to use copious amounts of water spray to provide cooling for the drill and cutter teeth. This water spray/vapor is then included in the air flow where it coats and clogs any dry filter with a mud.

To address these applications, a collector using water as the primary filtration medium can eliminate the problem of clogging or damaging dry filter media, but it brings with it additional problems including:

1. Excessive water consumption to adequately supply the wet spray nozzles.
2. Additional waste water deposited at the work site.

It is clear from the foregoing that there is a need for an efficient mechanism for the removal of airborne dust.

### SUMMARY OF THE INVENTION

The invention creates a dust collector. In the invention, dirty air is passed into a container. In this capacity, the container includes an inlet for acceptance of the dirty air and an outlet for exhaustion of clean air.

In the preferred embodiment, between the inlet and outlet within the container is a serpentine pathway into which a fogging apparatus emits a fog of water into the serpentine pathway. Alternatively, the container is configured to create a turbulence in the airflow through the fog to enhance contact between the fog and dirt particles to optimize precipitation of the wet dust.

Those of ordinary skill in the art readily recognize a variety of mechanisms which can be used to create the fog, including, but not limited to those described in: U.S. Pat. No. 4,990,290, entitled “Diffusion Fogger” issued to Gill et al. on Feb. 5, 1991; U.S. Pat. No. 5,501,401, entitled “Ultrasonic Fogging Device with Agitation Chamber” issued to Munk on Mar. 26, 1996; U.S. Pat. No. 5,523,028, entitled “Fogger Bar Assembly” issued to Reens, et al. on Jun. 4, 1996; U.S. Pat. No. 6,076,739, entitled “Indoor Air Quality Controlled Foggers” issued to Littleford, et al. on Jun. 20, 2000; U.S. Pat. No. 6,446,400, entitled “Steam Injection and Inlet Fogging in a Gas Turbine Power Cycle and Related Method” issued to Ranasinghe et al. on Sep. 10, 2002; U.S. Pat. No. 6,827,295, entitled “High Pressure Misting Nozzle with a Freely Movable Nozzle Pin” issued to Hendren et al. on Dec. 7, 2004; and U.S. Pat. No. 7,775,457, entitled “Foutain with Fog-Filled Illuminated Water Domes” issued to Schnackle on Aug. 17, 2010; all of which are incorporated hereinto by reference.

In this context, the term “fog” is different than “water droplets”. A “fog” tends to remain suspended in the air whereas “water droplets” are generally heavier than the air and naturally precipitated. In the present invention, when the dust is attached to the fog, then precipitation occurs.

One such fogger is commercially available from Dust Solutions Inc. by the trademark of “Dry Fog”, as described on their webpage “nodust.com”, incorporated hereinto by reference.

In this context then, the preferred embodiment creates a dust collector employing a container having an inlet for acceptance of dirty air and an outlet for exhaustion of clean air. The dirty air flowing into the container is subjected, in this embodiment, to a serpentine pathway between the inlet and the outlet while a fogging apparatus emits a fog of water in the pathway. The serpentine pathway assures that the dirty air mixes with an contacts the fog.

In one alternative embodiment of the invention, the container is generally “U” shaped allowing the dirty air to flow into one leg of the “U” and then exit the other leg of the “U”. In another embodiment, the container is linear in shape and is positioned horizontal so that the dirty air enters at the bottom and clean air is drawn out from the top.

In some embodiments, a plenum is positioned either before the outlet or immediately after the outlet to further encourage the precipitation and collection of the wetted dust.

A fan draws air from the outlet to pull the dirty air through the container. A collection basin is positioned at the bottom of the container to collect and exhaust precipitated wet dust. Exhaustion of the wetted dust in the collection basin is either by a periodic rinsing action with liquid water or a rotary airlock valve adapted to remove the precipitated wet dust.

The serpentine pathway within the preferred container is ideally created by a series of sloped baffles within the container. In one embodiment, these sloped baffles include precipitating channels allowing precipitated wet dust collecting on the sloped baffles to pass or be washed to the collection basin. This washing action on the baffle is created by N rinsing mechanisms. Each of the rinsing mechanisms are associated with one of the baffles and are configured to eject liquid water onto an upper surface of the baffle to wash precipitated wet dust from the upper surface to the precipitating channel.

Although the preferred embodiment of the invention has a square or rectangular cross section, an alternative embodiment has a generally circular cross-section. In this embodiment, the interior surface of said container is configured to create turbulence in air flowing through said container by either waves in the interior surface or baffles therein.

This embodiment allows the container to be positioned either in a vertical or a horizontal orientation and is more adaptable for confined spaces which will not permit the footprint of the rectangular container discussed earlier.

In the embodiment where the generally circular cross section container is positioned vertically, ideally a collection plenum is positioned at a bottom end of the container which allows the wet dust to collect therein.

In the embodiment where the generally circular cross section container is positioned horizontally, a collection basin/trough is positioned at the bottom of the container. Using either a periodic washing or an auger, the wet dust is removed from the collection basin/trough.

The invention, together with various embodiments will be more fully explained by the accompanying drawings and the following description thereof.

### DRAWINGS IN BRIEF

FIG. 1 is a diagram of the preferred embodiment of the invention.

FIG. 2 diagrams an alternative embodiment of the invention.

FIGS. 3A and 3B illustrate an alternative embodiment of the invention for horizontal applications.

FIG. 4 illustrates an alternative embodiment of the invention for vertical for vertical applications.

### DRAWINGS IN DETAIL

FIG. 1 is a diagram of the preferred embodiment of the invention.

In this preferred embodiment, the dust collector includes container 10 which has an inlet 11A and an outlet 11B. The flow of air into and out of container 10 is created by fan 12A. The airflow follows a serpentine pathway 11C between the inlet 11A and the outlet 11B as created by baffles 14.

A fogging apparatus 17 emits a fog of water into the serpentine pathway 11C. Dust within the incoming air adheres to the fog and precipitates to collection basin 13B. Periodically valve 16 opens to allow the precipitated wet dust to be discharged. In this context, a rotary airlock is optionally used for valve 16, although a manually operated valve is also contemplated.

As shown, the serpentine pathway 11C within container 10 is created by a series of sloped baffles 14. Precipitating wet dust can collect on the baffles 14 which must be periodically cleaned therefrom. This procedure is either done manually by curtailing operation of the dust collector, opening a hatch, and manually spraying water onto the baffles to wash the precipitated dust from the baffles; or, through the use of N rinsing mechanisms 15. Each of N rinsing mechanisms 15 are associated with one of the baffles 14 in the container 10 and are configured to periodically eject liquid water onto an upper surface of the baffle 14 to wash precipitated wet dust from the upper surface to drain via the precipitating channel 18 into the collection basin 13B.

In an alternative embodiment, baffles 14 are not sloped downward, but are sloped in an upward orientation. In this embodiment, precipitating channels/holes are created proximate to the walls of container 10, allowing collected wet dust to be washed using the rinsing mechanism 15 thereinto to eventually collect within the collection basin 13B.

In an alternative embodiment of this invention, fan 12A is not utilized. Rather, fan 12B draws the fog treated dirty air from container 10 into plenum 13A which allows the wet dust to precipitate and then be discharged. Fan 12B exhausts a clean air stream 11D.

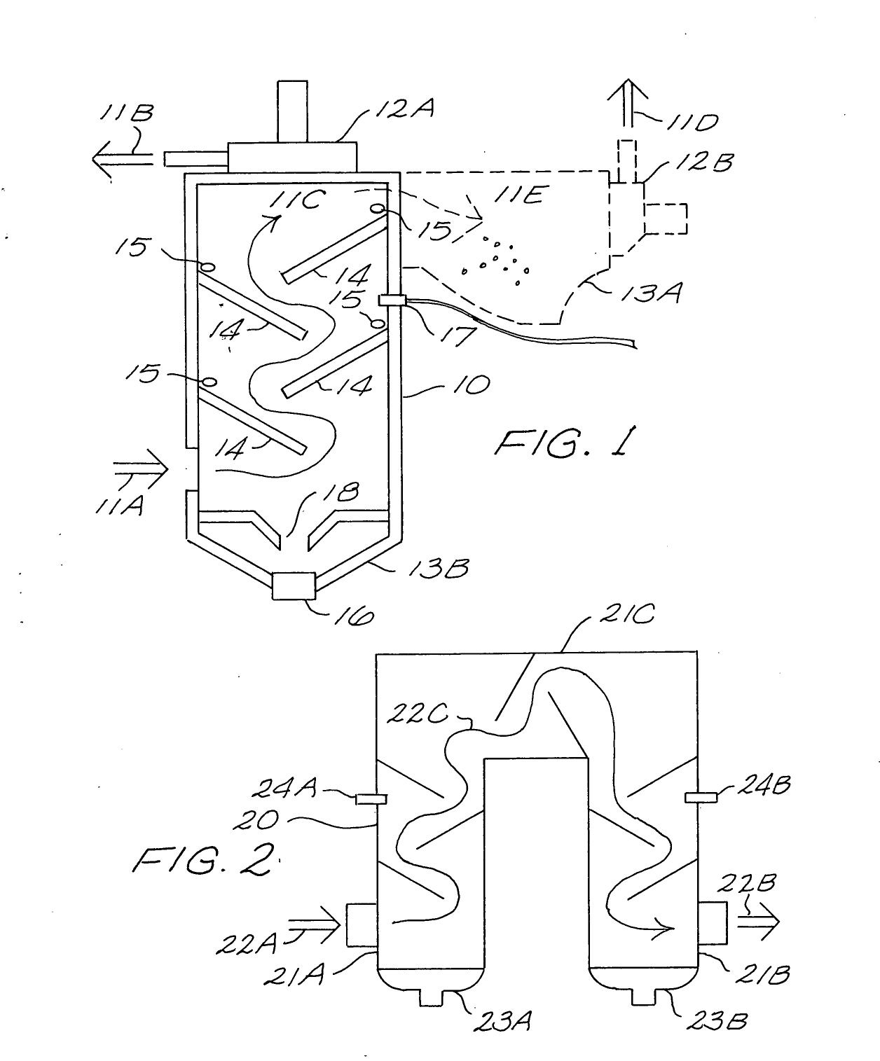

FIG. 2 diagrams an alternative embodiment of the invention.

The embodiment of the dust collector 20 is generally an inverted “U” shaped container having first leg 21A, base 21C, and second let 21B. First leg 21A has collection basin 23A which collects precipitated wet dust ; second leg 21B has collection basin 23B for precipitated wet dust. Note, an alternative is to place the “U” in an upright orientation.

Dirty air is introduced via inlet 22A which travels in a serpentine pattern 22C to exit via outlet port 23B.

In this embodiment, fogging mechanism 24A introduces a fog into first leg 21A while fogging mechanism 246 produces a fog in second leg 21B.

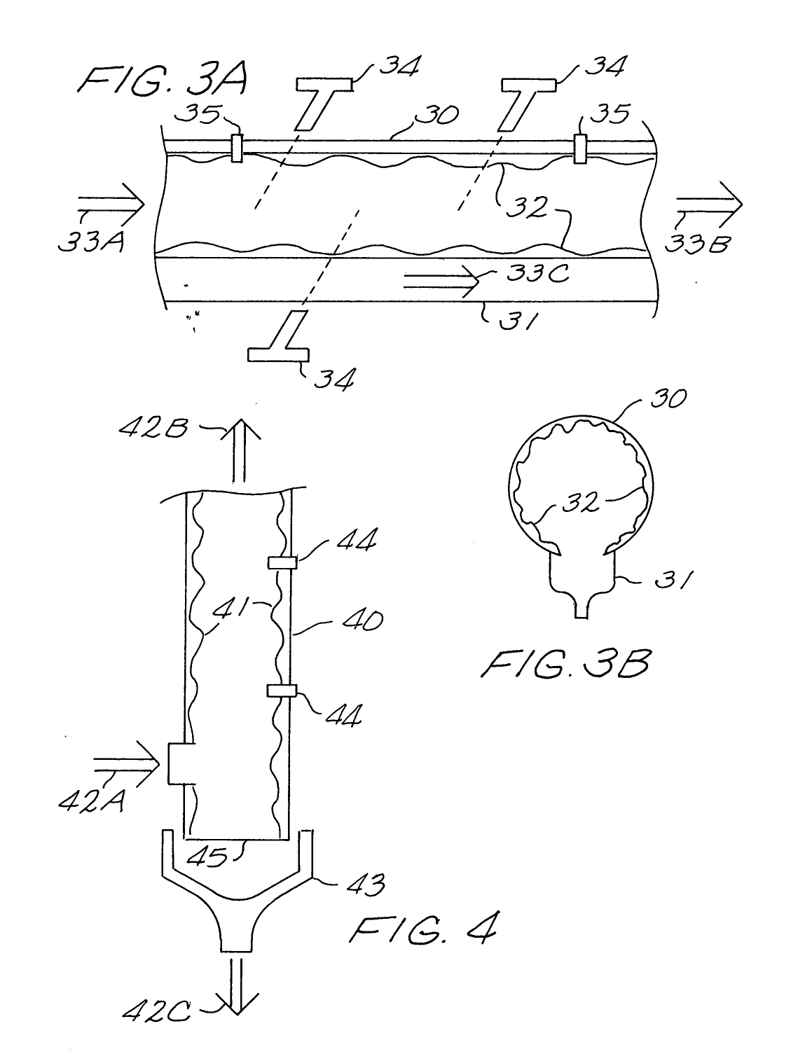

FIG. 3A (a side view) and FIG. 3B (an end view) illustrate an alternative embodiment of the invention for horizontal applications.

In this embodiment, container 30 has a generally circular cross-section. The interior surface 32 of container 30 is configured to create turbulence in air flowing 33A/33B through container 30. In this embodiment, the turbulence is created using an oscillating pattern on the wall's interior surface 32. An alternative embodiment employs baffles which may or may not be removable (removable illustrated 34).

Fogging mechanisms 35 provide the fog within container 30.

Collection trough 31 is positioned along the bottom of container 30 allowing precipitating wet dust to collect therein. Periodically, collection trough 31 is flushed with water to discharge the collected precipitated wet dust. Another embodiment utilizes an auger (not shown) to carry away the precipitated wet dust.

This embodiment of the invention is particularly applicable where space is restricted, allowing a pipe/conduit to be used to remove the dirty air from the remote site, drawn through the pipe/conduit and exit remotely.

FIG. 4 illustrates an alternative embodiment of the invention for vertical for vertical applications.

As with the embodiment of FIG. 3A and 3B, this embodiment has a generally circular cross section, but unlike the prior embodiment, the embodiment of FIG. 4 is positioned vertically. Container 40 has interior walls 41 adapted to create turbulence within the airflow coming from inlet 32A and exiting 42B through the top of container 40. Fogging mechanisms 44 produce a fog within container 40.

The fog from fog mechanisms 44 contacts the dirt within the airflow and precipitate through the open bottom 45 of container 40. This precipitation is collected in container 43 which is periodically emptied via valve 42C.

It is clear that the present invention, and all of its embodiments, provide for an efficient mechanism for the removal of airborne dust.

What is claimed is:

1. A dust collector comprising:
a) a container having,
1) an inlet for acceptance of dirty air,
2) an outlet for exhaustion of clean air, and
3) a serpentine pathway between the inlet and the outlet; and,
b) a fogging apparatus adapted to emit a fog of water into the serpentine pathway.

2. The dust collector according to claim 1, wherein the container is generally “U” shaped.

3. The dust collector according to claim 1, wherein the container is linear in shape and positioned horizontally.

4. The dust collector according to claim 3, wherein the container includes a plenum positioned in communication with the outlet.

5. The dust collector according to claim 4, further including a washing mechanism positioned at the bottom of the container for removal of precipitated dust.

6. The dust collector according to claim 1, further including a fan drawing air from the outlet.

7. The wet dust collector according to claim 1, wherein the container further includes a collection basin adapted to collect and exhaust precipitated wet dust.

8. The wet dust collector according to claim 7, wherein the collection basin includes a rotary airlock valve adapted to remove the precipitated wet dust.

9. The dust collector according to claim 7, wherein the serpentine pathway within the container is created by a series of sloped baffles within the container.

10. The dust collector according to claim 9, wherein the container further includes precipitating channels for each of the sloped baffles, said precipitating channels allowing precipitated wet dust to pass to the collection basin.

11. The dust collector according to claim 10, further including N rinsing mechanisms, each of said N rinsing mechanisms associated with one of the baffles in the container and configured to selectively eject liquid water onto an upper surface of the baffle to wash precipitated wet dust from the upper surface to drain via the precipitating channel.

12. A dust collector comprising:
a) a container having,
1) an inlet for acceptance of dirty air,
2) an outlet for exhaustion of clean air,
3) a serpentine pathway between the inlet and the outlet, and,
4) a collection basin adapted to collect and exhaust precipitated wet dust;
b) a fan drawing air from the outlet; and,
c) a fogging apparatus adapted to emit a fog of water into the serpentine pathway.

13. The dust collector according to claim 12, wherein the container further includes a plenum positioned in communication with the outlet.

14. The dust collector according to claim 13, wherein the serpentine pathway within the container is created by a series of sloped baffles within the container.

15. A dust collector comprising:
a) a container having,
1) an inlet for acceptance of dirty air,
2) an outlet for exhaustion of clean air,
3) a fan drawing air from the outlet through the container; and,
b) a fogging apparatus adapted to emit a fog of water into the container.

16. The dust collector according to claim 15, wherein the container further includes:
a) a serpentine pathway between the inlet and the outlet; and,
b) a collection basin adapted to collect and exhaust precipitated wet dust.

17. The dust collector according to claim 15, wherein said container has a generally circular cross-section, and wherein the interior surface of said container is configured to create turbulence in air flowing through said container.

18. The dust collector according to claim 17,
a) wherein the container is positioned in a manner causing the airflow therethrough to be generally vertically;
b) wherein the inlet is positioned proximate to a bottom portion of the container; and,
c) further including a collection plenum positioned at a bottom end of the container.

19. The dust collector according to claim 17,
a) wherein the container is positioned in a manner causing the airflow therethrough to be generally horizontally; and,
b) further including a collection basin positioned at the bottom of the container and adapted to collect precipitated wet dust therefrom.

20. The dust collector according to claim 19, further including a flushing mechanism adapted to periodically pass water through said collection basin to removed precipitated wet dust therefrom.
